(19) United States
(12) Patent Application Publication
(10) Pub. No.: US 2010/0315379 A1
(43) Pub. Date: Dec. 16, 2010

(54) Display Devices With Integrated Optical Components For Use in Position Detection

(76) Inventors: Matthew Allard, Skudai Johor (MY); Simon James Bridger, Auckland (NZ); Nigel Devine, The Warren (SG)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/785,604

(22) Filed: May 24, 2010

(30) Foreign Application Priority Data
May 22, 2009 (AU) 2009902351
May 22, 2009 (AU) 2009902354

(51) Int. Cl. G06F 3/042; H01J 9/20

(52) U.S. Cl. 345/175; 445/24

(57) ABSTRACT

Displays, such as LCD displays, can include integrated optical components such as energy emitters, detectors, reflective material, etc. for position detection based on energy traveling over a touch surface. A display device comprising a panel can accommodate at least one optical component to direct light over the touch surface and/or to receive light directed over the touch surface. The touch surface may be part of the display or a layer atop the display. The device with integrated component(s) can be included in a display, which includes a display bezel. Embodiments may use a frame structure to position an optical component close to the top surface of the display and may be mounted to a flat panel atop the panel bezel and beneath the display bezel and/or a transparent member can interface with a support member which supports optical component(s) that direct and/or receive light traveling over the transparent member.

### PRIORITY CLAIM

The present application claims priority to Australian Provisional Patent Application No. 2009902351, filed 22 May 2009 by Matthew Allard and Simon Bridger and entitled “A Reduced Height Touch Screen System,” which is incorporated by reference herein in its entirety; the present application also claims priority to Australian Provisional Patent Application No. 2009902354, filed 22 May 2009 by Matthew Allard and Nigel Devine and entitled “A Display Comprising Integrated Touch components,” which is incorporated by reference herein in its entirety.

### BACKGROUND

Touch-enabled displays and other devices that rely on detection of a position of one or more objects (such as a stylus, a finger or fingers) relative to a panel have become increasingly popular. For example, one type of touch-enabled display features one or more image sensors used to determine the position of an object (or objects) relative to the display area. A computer or display manufacturer may rely on an outside vendor to build and/or design the image sensors and other hardware (generally “optical components”).

For instance, computer/display manufacturers may rely on a vendor to provide panels with cameras or other optical hardware mounted in a precise location, with the panel then mounted by the computer/display manufacturer to a display device. This practice has introduced complications and delay in the manufacturing process. For example, if a panel is damaged, the panel and the relatively expensive hardware are usually both discarded. If the panel and optical hardware are provided separately, mounting the hardware may take time and require relatively skilled workers, specialized facilities, and/or complex tools that are uneconomical for the computer/display manufacturer to deploy.

### SUMMARY

Embodiments configured in accordance with one or more aspects discussed below can reduce the cost and complexity of assembly of touch-enabled computing systems and/or can allow manufacturing stages of assembling display-related and touch-related components to be fully or partially integrated.

Embodiments include displays having one or more integrated optical components for use in position detection. The optical components are used in directing energy across a touch surface from one or more edges or corners of the surface, reflecting energy, and/or detecting interference with energy. The optical components can include, but are not limited to, energy emitters, detectors, reflective material, and the like. The touch surface may correspond to part of the display, such as the polarizer of an LCD display, or a transparent layer atop the display.

In one embodiment, a flat panel display device (i.e. any substantially “flat” display device, such as a liquid crystal diode (LCD) display) comprises a panel bezel. The panel bezel is structured to surround the periphery of the display device and to secure the internal components of the display device (e.g., for an LCD, the polarizer, active area, etc.). In accordance with some embodiments of the present subject matter, the panel bezel also accommodates at least one optical component of the touch detection system.

The flat panel display with integrated optical component(s) can then be included in a completed display, which typically includes a display bezel that provides an attractive and/or protective border that (along with the LCD surface or any transparent layer) defines the outer surface of the completed display. In some embodiments, additional optical components are positioned between the display bezel and the panel bezel, although in some embodiments all optical components are accommodated by the panel bezel.

In one embodiment, a frame structure is configured to position an optical component close to or beneath the top surface of the flat panel display device when the frame structure is positioned over the display device. For example, the frame may be mounted to an LCD or other flat panel atop the panel bezel, with the display bezel then placed over the frame.

In another embodiment, a transparent member having a topside and an underside is placed over the display panel. A support member is provided on the underside of the transparent member and protrudes at least in part past the transparent member. An optical component is provided on the part of the support member protruding outside the transparent member such that the sensor is of sufficient height so as to protrude above the transparent member and have a field of view encompassing in part the topside of the transparent member. The transparent member and support member can then be placed over the display device. The optical component will be proximate both the surface of the display device and with the transparent layer acting as the touch surface.

These illustrative embodiments are mentioned not to limit or define the limits of the present subject matter, but to provide examples to aid understanding thereof. Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

A full and enabling disclosure is set forth more particularly in the remainder of the specification. The specification makes reference to the following appended figures.

FIG. 1A is a diagram showing one embodiment of an assembled touch-enabled display.

FIG. 1B is a diagram showing a relationship between a display bezel and a panel bezel.

FIG. 2 is a diagram showing an illustrative embodiment of a display device with integrated optical components.

FIG. 3 is a diagram showing a cross-sectional view of the display device shown in FIG. 2.

FIG. 4 is a diagram showing another illustrative embodiment of a display device with integrated optical components.

FIG. 5 is a diagram showing a cross-sectional view of another illustrative embodiment of a display device with integrated optical components.

FIG. 6 is a diagram showing a cross-sectional view of a still further illustrative embodiment of a display device with integrated optical components.

FIG. 7 is a diagram showing another view of the display device shown in FIG. 6.

FIG. 8 is a diagram showing an illustrative embodiment of a support frame that can be fitted to a display device.

FIG. 9 is a diagram showing the support frame of FIG. 8 fitted to a display device.

FIGS. 10-12 are diagrams showing another embodiment for support of optical components.

FIG. 14 illustrates an example of components of a display device, particularly a liquid crystal diode (LCD) device.

Reference will now be made in detail to various and alternative exemplary embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment. Thus, it is intended that this disclosure includes modifications and variations as come within the scope of the appended claims and their equivalents.

In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure the claimed subject matter.

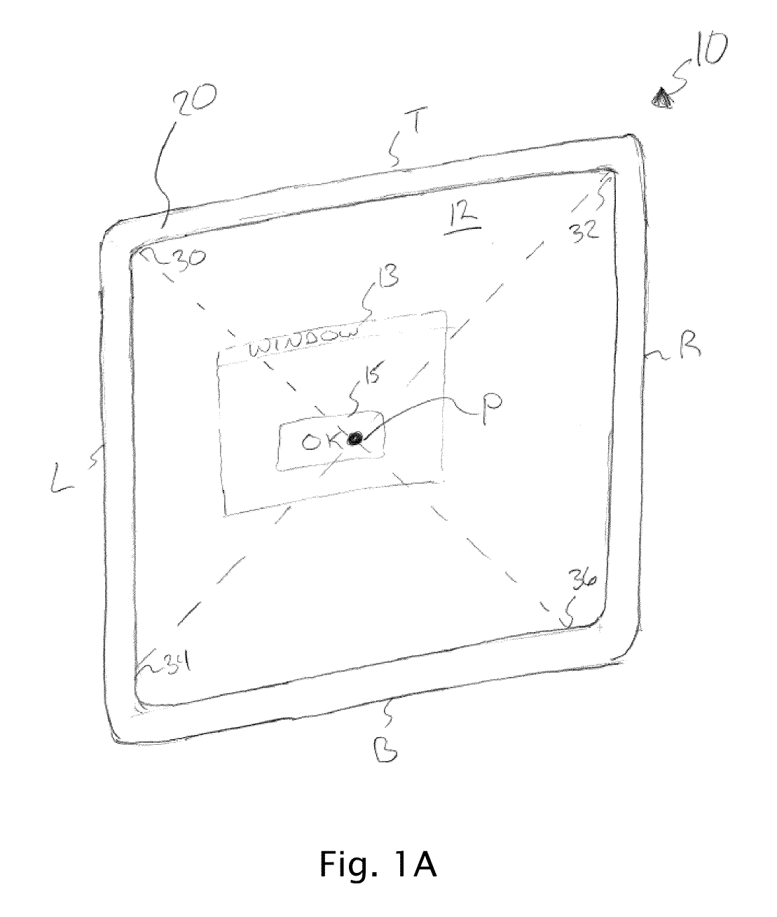

FIG. 1A is a diagram showing one embodiment of an assembled touch-enabled display 10. As used herein, the “completed display” refers to a screen or other assembly ready for use in a touch-enabled computing system—i.e., a monitor, screen, television, etc. ready for connection of display components to a suitable driver to provide signals representing displayed content (e.g., a VGA, DVI, HDMI, or other connection to a computing system) and connection of position detection components (e.g., a USB, serial, or other connection to the same computing system or a processor used to relay position data to the computing system). In this example, the completed display has a top T, bottom B, left side L and right side R. As noted above, the “touch surface” can refer to the outermost surface of the display device or to a layer above/atop the display device. “Above” and “atop” refer to the direction along the vector perpendicular to the plane of the display device and moving away from the side of the display device that faces outward and renders displayed content (i.e. the “front” of the display device).

The “display device” refers to internal components of the completed display that render information on a display surface. In this example, a display device 12 comprises a Liquid Crystal Display (LCD), though any other display technologies (e.g., organic light emitting diode (OLED), cathode tube (CRT), etc.) could be used. As shown here, the display device 12 is surrounded by a screen bezel 20. Screen bezel 20 represents a structure surrounding the internal components of touch-enabled display 10 and is the outermost structural part of the completed display (apart from, of course, display device 12 or protective layers thereof, controls, cables and connectors, etc.).

Display 10 features integrated optical components configured in accordance with one or more aspects of the present subject matter. The optical components can be used to detect the position(s) of one or more touches at which an object contacts a touch surface and/or a position of an object relative to a touch surface. For example, as shown in FIG. 1A an interface comprising a window 13 and button 15 are rendered using display device 12 based on signals from a processor (not shown).

A touch point P can be detected using any number of techniques to detect, for example, selection of button 15. For instance, as is known in the art, triangulation can be used. In this example, the dashed lines are used to triangulate point P based on detecting shadows cast by an object (e.g., a finger, stylus, etc.) or other interference with energy that is passing over the display 12. One or more energy sensors (e.g., line or area detectors) can be used to determine changes in a pattern of light reflected by material at the perimeter of the area of display 12. For instance, light can be emitted from an optical unit at points 30 and/or 32 towards a retroreflective material positioned around the perimeter. The object at point P may cast shadows at points 34 and 36 that can be detected by the optical unit(s) and, using the shadow locations and known geometry of the system, the processor can determine the position of point P.

Other techniques could be used to determine the location of point P, of course. As another example, so-called active bezels may comprise illumination components (e.g., optical components such as LEDs, fluorescent tubes, light pipes, and/or other components) used to direct energy across the touch surface. Based on interruption of light from the active bezel, position information can be derived. As a further example, image sensors can be used to take an image of an object at or near the touch surface, with image processing techniques used to determine the object's location and/or motion.

Embodiments of the present subject matter relate to the position of optical components relative to the display device 12 and other components. Typically, the display device 12 includes a bezel of its own that is used to secure the components of the display device. FIG. 1B is a diagram showing an overall relationship between the screen bezel and a bezel 18 of the display device (referred to as a “panel bezel 18” below). Screen bezel 20 is shown using dashed lines here so as not to obscure the other components. Display device 12 comprises a generally planar panel—as shown here, there are two substantially planar portions defining edges therebetween. Display device 12 is intended to include any substantially flat panel type of display, though of course such displays are not truly “flat” but have a thickness.

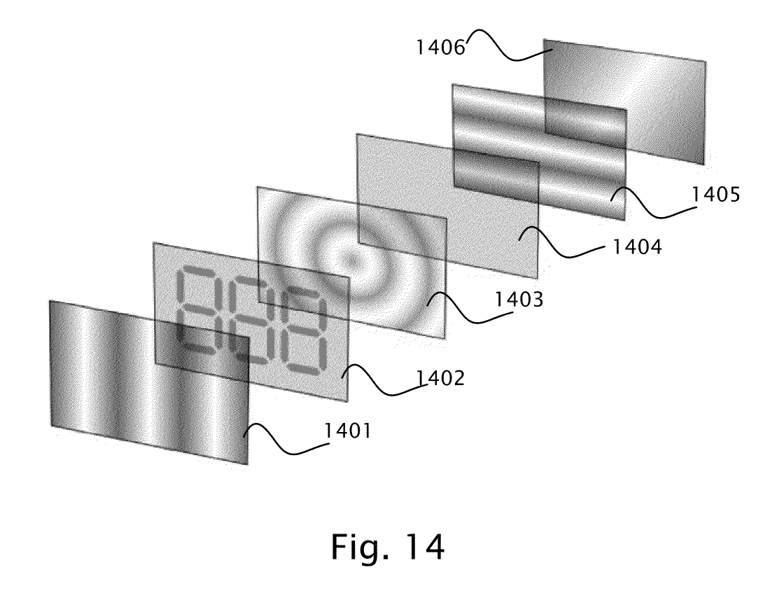

For instance, if display device 12 comprises an LCD display, the display can comprise a sandwich structure, with a polarizer (or, in some embodiments, a protective layer atop the polarizer) defining the outward-facing plane of the display device. One example of an LCD sandwich structure is described in the article “LCD Layers,” available at http://en.wikipedia.org/wiki/File:LCD_layers.svg?powerset and reproduced in FIG. 14. In this example, the sandwich comprises a polarizer 1401 (in this example a vertical filter film) to polarize the light as it enters. A glass substrate 1402 features indium tin oxide (ITO) electrodes shaped to determine what will appear when the LCD is turned on, with vertical ridges etched on the surface so the liquid crystals are in line with the polarized light. The display of this example also features twisted nematic liquid crystals 1403 and a glass substrate 1404, the substrate having common electrode film (ITO) with horizontal ridges to line up with the horizontal filter 1405. Horizontal filter film 1405 is used to block/allow light, while a reflective surface 1406 is used to send light through the sandwich structure when light is not blocked by operation of the display. Surface 1406 can be replaced with a backlight for backlit LCDs. For color LCDs, suitable subpixels and filters can be used, and variations of the LCD design will be within the knowledge of one of ordinary skill in the art. Of course, any suitable display technology can be used and this description is for purposes of example only.

Returning to FIGS. 1A-1B, a panel bezel 18 is used to secure and protect the LCD components and extends around the edges and slightly over the outward-facing plane. Optical components including, but not limited to, reflective structures, detectors, light sources, and related items can be positioned in a number of different locations relative to screen bezel 20 and display device 12. For example, in some embodiments an optical component, such as an integrated light source and detector, can be clipped to a protective layer placed atop display device 12 and panel bezel 18. Reflective material can be mounted to the protective layer, and then screen bezel 20 then is placed over the display device and protective layer.

Although such an arrangement may provide numerous advantages, it has been found that in at least some situations a higher degree of integration between the display device and optical components is desired. Thus, various examples are presented below in which one or more optical components are integrated directly or indirectly with display device 12. As will be discussed below, this can simplify the assembly process and/or reduce the protrusion of the optical components above the touch surface.

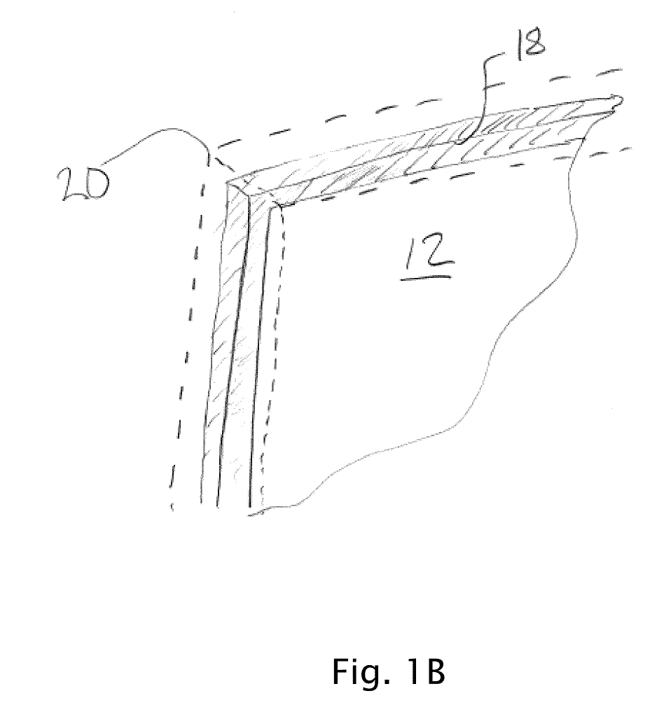

FIG. 2 is a diagram showing an illustrative embodiment of a display with integrated optical components. In this example, rather than clipping or attaching optical components to a separate overlay, the optical component(s) are attached to a layer included in the structure of display device 12, In particular, display device 12 is overlaid with a transparent layer 22, which may be glass, plastic, or some other material. Optical components, such as illumination/detector assembly 21 and/or structural member 26 with reflective material 28, can be attached to transparent layer 22 and can be secured by panel bezel 18. As shown here, panel bezel 18 includes a portion 18′ that extends parallel to the top plane of display device 12 and serves to cover and protect the optical components (as well as the components of display device 12). An edge portion 18″ extends about the edges of display device 12. Additionally, the bezel may include a back planar portion (not visible) such that the bezel has an overall “C” shape; however, in some embodiments no back planar portion is needed (e.g., if the bezel is sufficiently attached at the edges).

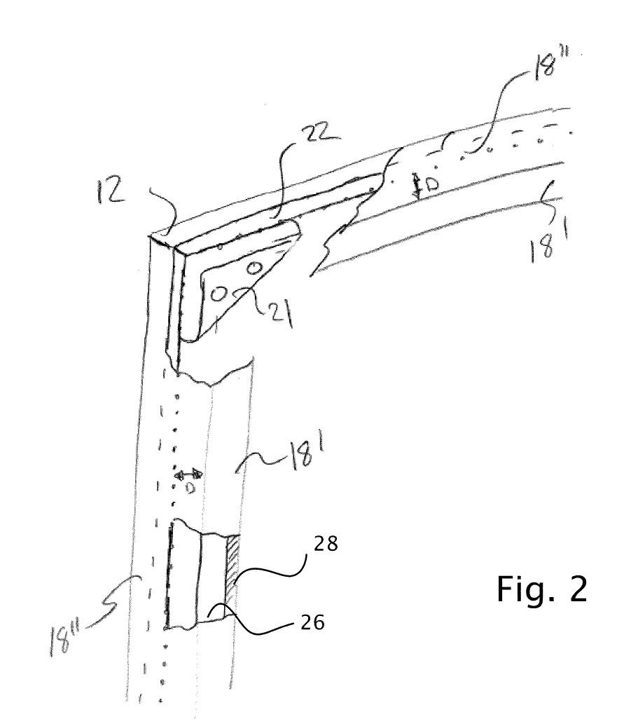

FIG. 3 is a diagram showing a cross-sectional view of the display shown in FIG. 2. In this example panel bezel 18 is visible surrounding the periphery of the display device 12 and a screen bezel 20 surrounding the periphery of the display device 12 and panel bezel 18 is also shown. Display device 12 is illustrated as an LCD device, and the LCD is formed in a manner which would be readily known to a person skilled in the art. The LCD therefore typically comprises a polarizer 14 and active area 16. In this embodiment, substantially flat transparent layer 22 is visible atop the display device 12. The transparent member 22 may be adjoined the LCD via an adhesive member 24. The transparent member 22 is preferably formed of glass, plastic or the like and the adhesive member 24 may be glue, tape or the like.

Provided atop the transparent member 22 around at least part of the periphery is a support member 26 having a reflective member 28 affixed. Although not shown in this view, one or more optical units (such as illumination/detector assembly 21) can be positioned in a similar manner, taking the place of elements 26 and 28.

Additionally or alternatively, the arrangement shown in FIG. 3 could be used for reflective member 28, but with energy emitters, detectors, and the like placed using a different technique. For example, the arrangement of FIG. 3 could be used in combination with a optical detector/emitter assembly that is clipped to the panel bezel 18 and thus sits between bezel 18 and screen bezel 20. As another example, a detector/emitter assembly could be placed between bezel 18 and layer 22, with reflective material mounted using another technique (e.g., directly to layer 22 independently of bezel 18, to a member extending from screen bezel 20, etc.).

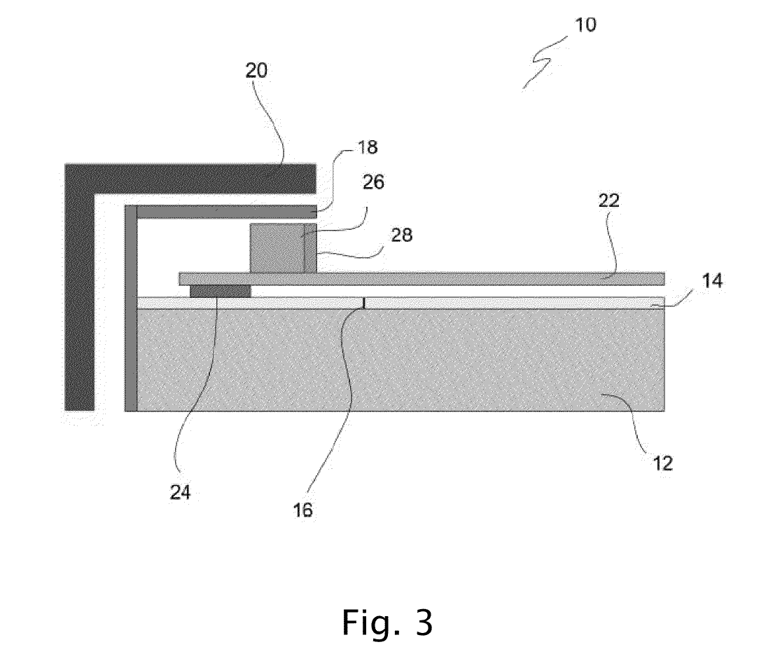

In some embodiments, no transparent layer 22 is used. Instead, another component of display device 12 (such as the polarizer) comprises the outermost surface. For example, the display shown in FIG. 4 is generally configured in a similar manner to the display shown in FIG. 2, but does not include layer 22. Instead, optical components such as illumination/detector assembly 21, support member 26 with reflective member 28, and the like are adhered to components of display device 12 (polarizer 14 may comprise the outermost surface but is not illustrated separately for purposes of clarity in FIG. 4).

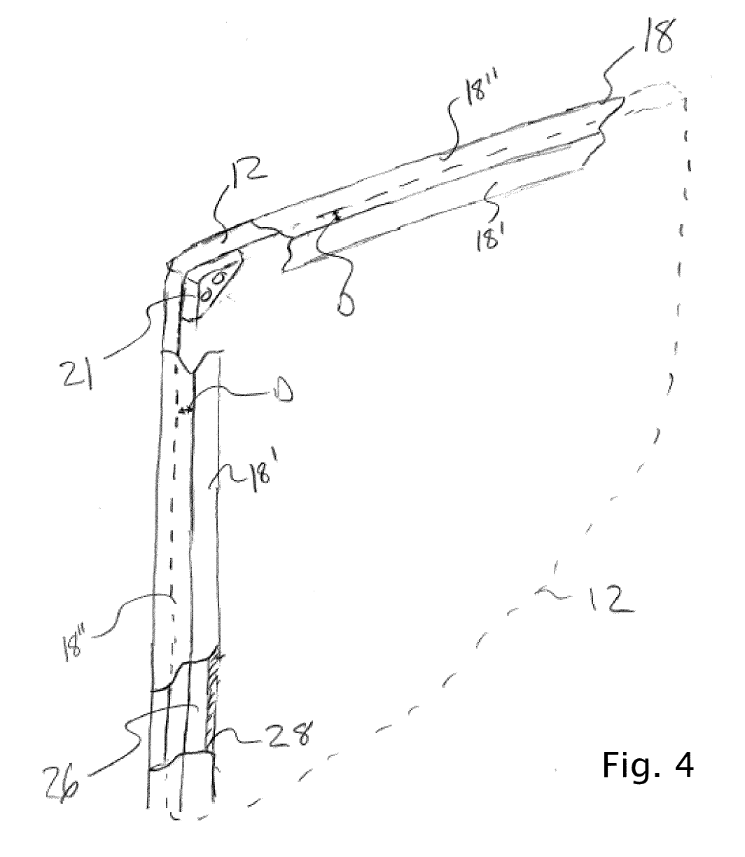

FIG. 5 is a diagram showing a cross-sectional view of another illustrative embodiment of a display with integrated optical components. As discussed with reference to FIG. 4, components can be mounted directly to the display device. In this example, display device 12 comprises a polarizer 14 to which the optical components are mounted. Located within the panel bezel 18 is a frame member 26A attached directly to the polarizer 14 of the display device 12. The frame member 26A is adapted to support the panel bezel 18 and also provide a mounting area for a reflective member 28. Additionally, as shown here, panel bezel 18 and frame member 26A can include a shaped area 27 (e.g., a recess, notch, or the like) to receive a corresponding portion 20A of the screen bezel 20, such that the screen bezel 20 is attached securely to the panel bezel 18 and as such, to the display device 12.

As mentioned above, other optical components such as detectors, emitters, and the like may also be affixed to display device 12. For example, at one or more corners, an emitter, detector, or combined emitter/detector assembly could be positioned beneath panel bezel 18 in place of frame member 26A and reflective member 28. As also mentioned above, other arrangements could be used, e.g., clipping emitters and/or detectors to the panel bezel, using emitters and/or detectors beneath bezel 18 with an externally-provided reflective member, etc.

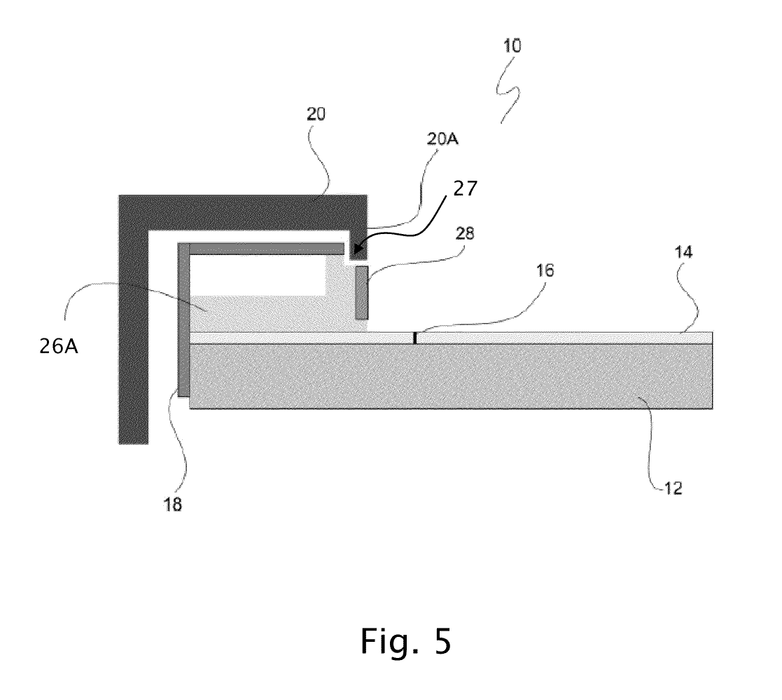

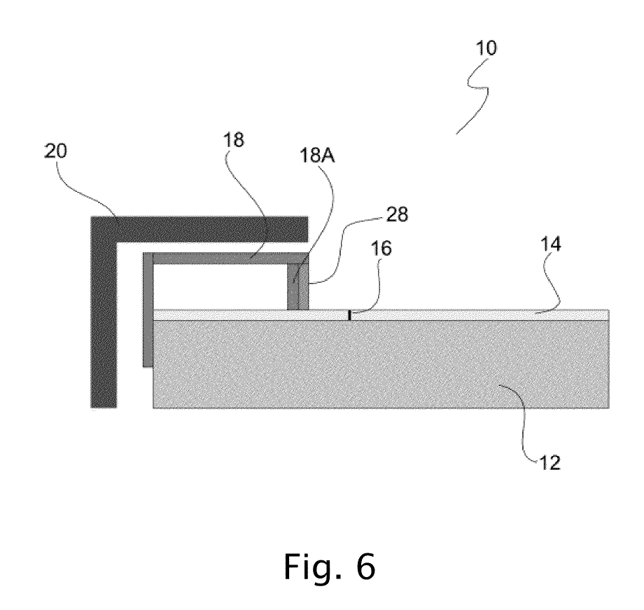

FIG. 6 is a diagram showing a cross-sectional view of a still further illustrative embodiment of a display with integrated optical components and FIG. 7 is a diagram showing another view of the display shown in FIG. 6. In this example, a display device 12 is again surrounded at its periphery by a panel bezel 18. The display device 12 comprises typical LCD components such as an active area 16 and polarizer 14 (polarizer 14 and active area 16 are not shown in FIG. 7 for purposes of clarity). Surrounding the panel bezel 18 is a screen bezel 20 (not shown in FIG. 7).

The panel bezel 18 comprises a support portion 18A, which extends towards the display device 12 and is adapted to support an optical component. As can be seen in FIG. 7, support portion 18A extends back towards display device 12, while portions 18′ and 18″ of panel bezel 18 extend in a similar manner as previously shown. For example, support portion 18A can be used to provide a recess or notch shaped to receive reflective member 28 as shown in FIG. 6. Additionally or alternatively, support portion 18A can be shaped and positioned to allow another optical component, such as a detector and/or emitter, to be placed at the location of reflective member 28 at edge or corner portions. As noted before, the arrangement used for the detector/emitter/etc. and for the reflective components can be the same or a mixture of arrangements can be used.

In any of the embodiments of the present subject matter, it is intended that it is understood that the panel bezel 18 may be formed of any strong material such as plastic, metal, polymer or the like. The screen bezel 20 may be formed from any rigid material such as plastic, metal, polymer or the like. Although the examples above refer to an LCD and panel bezel, as noted above embodiments may be employed with any substantially flat display technology including, but not limited to, OLED, plasma or Cathode Ray tube.

Examples of assembly procedures will now be described. In the case of the embodiment of FIGS. 2-5, the transparent member 22 (if used) is affixed to the display device 12 by adhesive member 24. Next, the support member 26 or frame member 26A is affixed to the transparent member 22 (FIGS. 2-3) or directly to the display device 12 (FIGS. 4-5). This is achieved by any known attaching means including glue, tape, welding, another attachment mechanism, or the like. Then the reflective member 28 is affixed to the support member 26/frame member 26A. Finally, the panel bezel 18 is affixed around the periphery of the display device 12. The panel bezel 18 fits around the entire periphery of the display device 12 and extends a small way across the top of the display device 12, for example 5 mm or 10 mm in some embodiments. The panel bezel 18 is affixed using known means such as glue, tape, welding, clipping, or any other suitable attachment mechanism. In the embodiment of FIGS. 6-7, the LCD is assembled with panel bezel 18 and the reflective member 28 (and/or other optical components) is positioned/affixed to the support portion 18A of the panel bezel 18 in the manner described above.

At least one energy emitter (not shown) and energy sensor (not shown) may be attached either before attachment of the panel bezel 18, as described above, or after. If the emitter or sensor is to be positioned between device 12 and the bezel, it may of course be inserted at an appropriate point prior to securing panel bezel 18 to device 12.

The display device 12 and bezel 18 as assembled in the manner described above, is now ready to be integrated into any device requiring a touch screen. For example this may be a monitor, television, all-in-one Personal Computer or laptop. The screen bezel 20 is attached over the panel bezel 18, by manner of normal attachment such as gluing or taping, or by an attachment portion 20A. In this manner, the display device 12 may be inserted into any device required.

In an embodiment of the present invention where there is no transparent member 22, it is desirable to strengthen the display device 12 utilizing a hard polarizer 14 for example. Other means of strengthening the display device 12 will be within the capabilities of a person skilled in the art.

As noted above, in some embodiments at least one optical component (e.g., a detector, emitter, detector/emitter assembly, and/or reflective member) is positioned between the panel bezel 18 and remainder of the display device 12 at the perimeter. In some embodiments, all optical components used for position detection are so integrated with the display device. However, in some embodiments at least one optical component is mounted to a support frame that is fitted to panel bezel 18/display device 12.

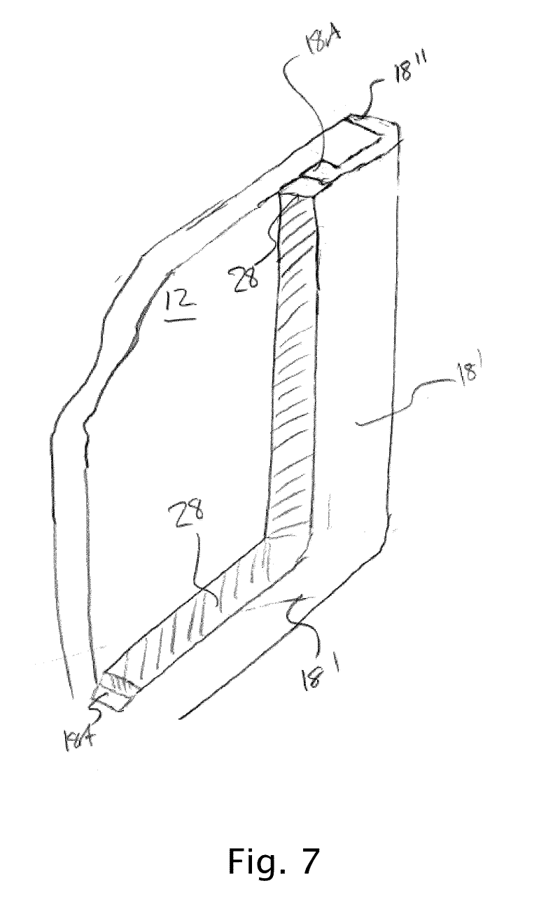

FIG. 8 is a diagram showing an illustrative embodiment of a support frame 19 that can be fitted to a display device. In this example, frame 19 comprises an outward-facing portion 19′ that is parallel to the outward-facing plane of the display device 12 and an edge portion 19″. At the corner shown here, a support member 23 is shown and is adapted to receive an optical component, shown here has an emitter/detector assembly 21. Support frame 19 can be constructed of any suitable material and may include one or more members in contact with support member 23 at the corner or support member 23 may itself link the members of support frame 19. In some embodiments, support member 23 comprises plastic that can be secured using UV glue. For instance, assembly 21 may be secured to support member 23 using UV glue and UV glue can be applied to the underside of support member 23 when positioning frame 19 on a display device.

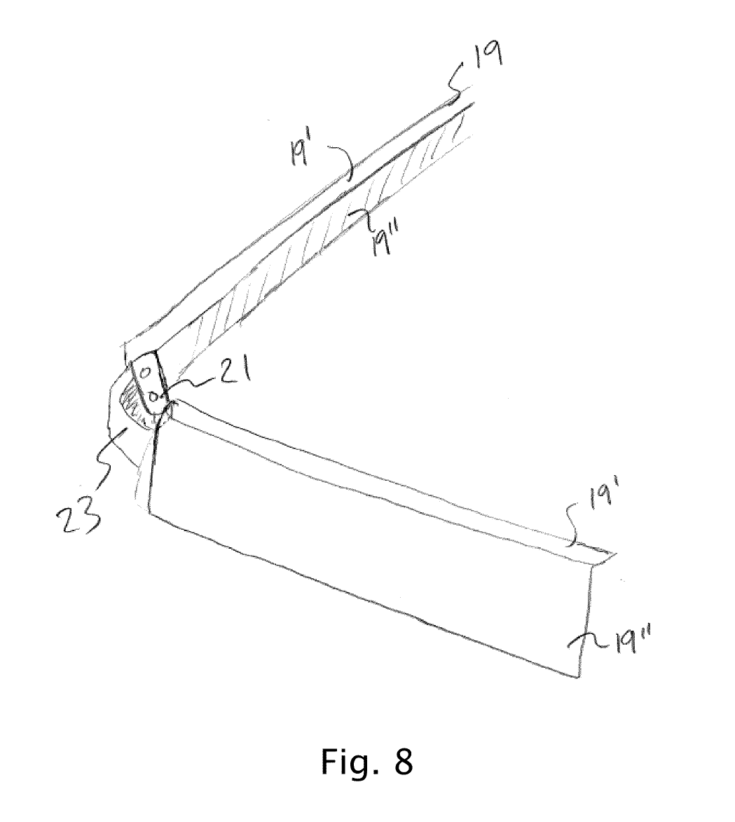

For example, support frame 19 can be fitted to a display device 12 over the panel bezel 18 as shown in FIG. 9, with support member 23 glued to or otherwise attached to panel bezel 18 and/or a surface of device 12 (e.g., a polarizer or transparent layer of the device). The display device 12/panel bezel 18 may comprise an embodiment configured in accordance with aspects of one or more of FIGS. 2-7 above, i.e., with at least one optical component between bezel 18 and the remainder of the LCD. However, in some embodiments, a “plain” display device 12 and bezel 18 (i.e., with no integrated optical components) may have frame 19 fitted thereto. Reflective material may be attached to frame 19 and/or reflective material may be provided in another manner. In any event, after frame 19 is fitted to a display device 12, a screen bezel 20 can be positioned to cover frame 19, with frame 19 positioned between panel bezel 18 and screen bezel 20.

The approach of FIGS. 8-9 could be applied in assembling an LCD panel as well. Particularly, frame member 19 could be used as the LCD bezel and used to secure the LCD sandwich, with support member 23 glued to the LCD polarizer or a transparent layer above the polarizer.

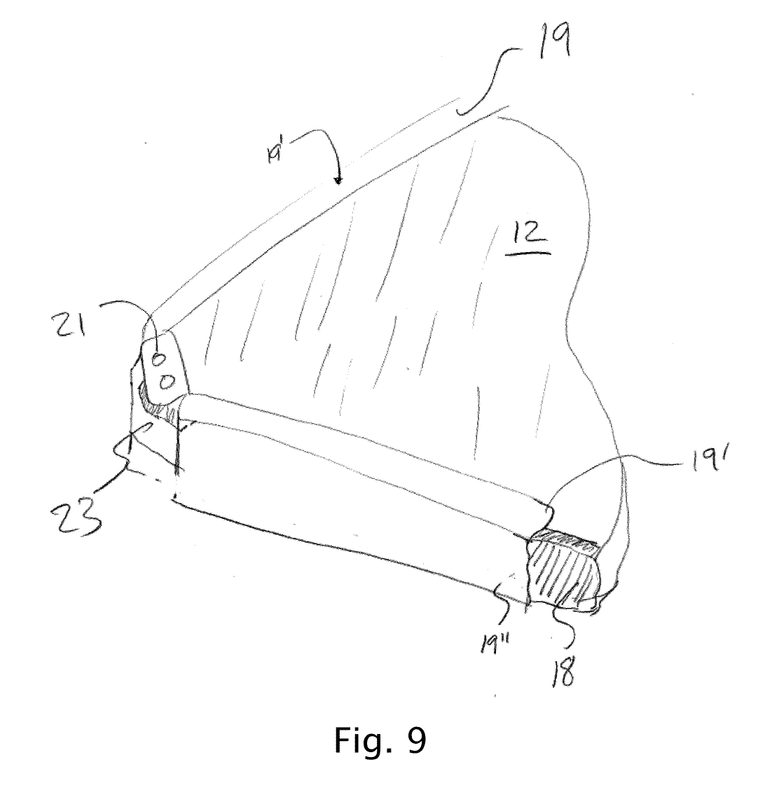

FIG. 10 shows another exemplary embodiment of touch screen components. In this example, a touch screen system 110 comprises a substantially flat transparent member 112, at least one support member 114 provided behind the transparent member 112 and at least one optical component 116 attached to the support member 114 so as to extend above the transparent member 112.

As shown in FIG. 10, the transparent member 112 is modified so as to expose a corner portion 112a, the support member 114 is fixedly attached, such as by glue or the like, to the underside of the transparent member 112, such that a portion 114a of the support member 114 protrudes into the corner portion 112a of the transparent member 112. For instance, a top side of support member 114 can be attached to the underside of the transparent member 112, either directly (e.g., using adhesives, etc.) or by way of one or more intermediate layers of material.

There is further provided a reflector support member 120, which may be placed around the periphery and on the topside, of the transparent member 112. The reflector support member 120 may have a reflective member 122, on a face of the reflector support member 120 so as to face the corner portion 112a. FIG. 10 shows only one corner of the touch screen system 110 but it will be understood that the technique may be provided at any number of corners (or even along edges) of a touch screen system 110.

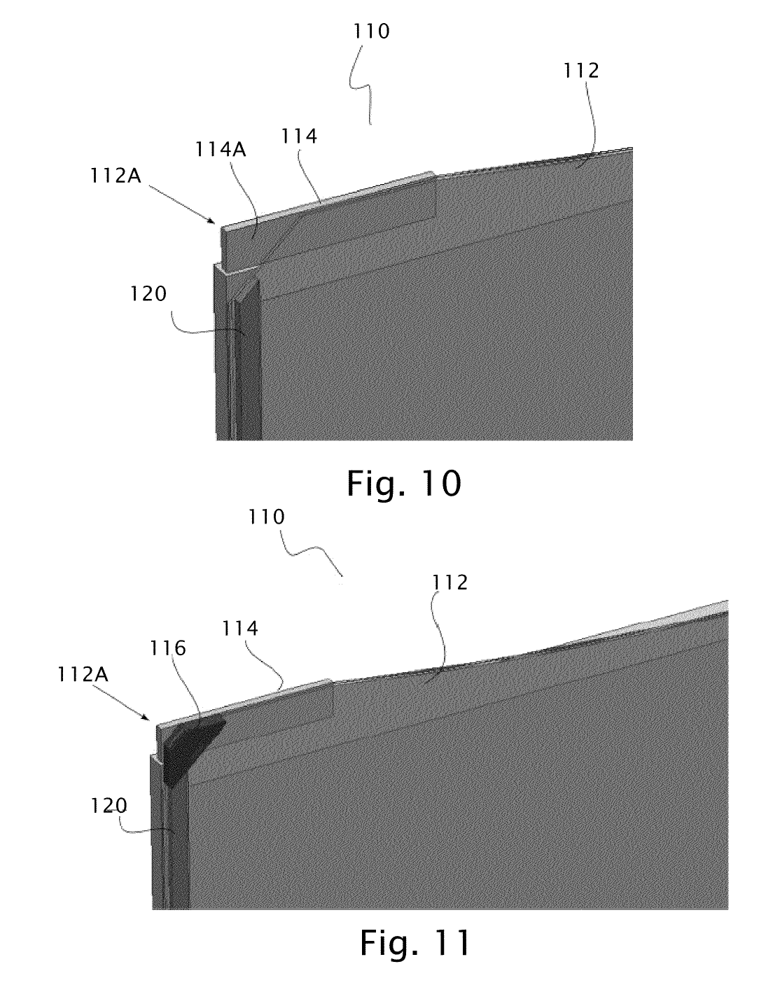

As shown in FIG. 11, fixedly attached to portion 114a of the support member 114 is an optical component 116, shown here as a sensor designed to detect the level of energy within its field of view. This energy may be light for example, in this manner the optical component would be an optical sensor. The optical component is attached to the support member 114 in a fixed arrangement, such as by glue or the like, so that the optical component extends above the transparent member 112 a sufficient height X so as to allow the field of view of the optical component 116 to encompass at least a portion of the top side of transparent member 112, though in some embodiments the field of view may extend substantially across the topside of the transparent member 112.

Further provided in the optical component 116, or around the periphery of the transparent member 112 is at least one energy source (not shown). In the case that the optical component 116 is an optical sensor, the energy source may be Light Emitting Diodes (LEDs), fluorescent tubes or the like.

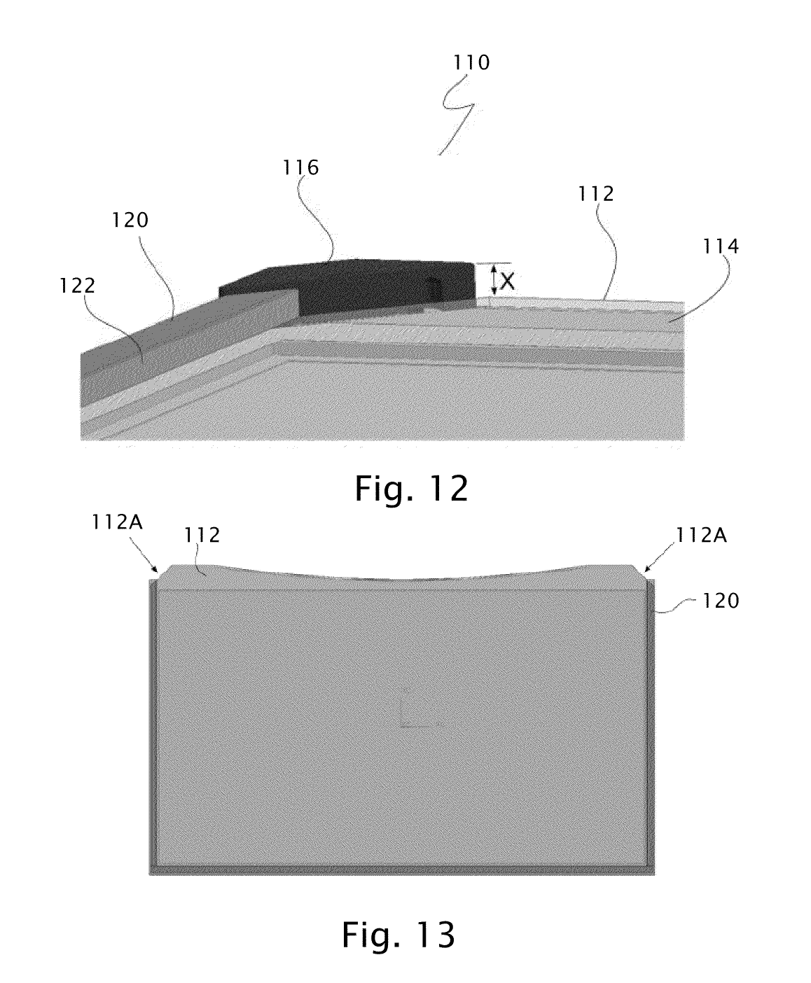

In use, the energy source emits energy such as light across the topside of the transparent member 112, the reflective member 122 (see FIG. 12) reflects the energy across the topside of the transparent member in a substantially uniform manner. The optical component 116 can detect and measure the level of energy across the topside of the transparent member 112, due to the energy being reflected towards the optical component 116 by the reflective member 122. If an object, such as a finger or stylus, is placed on or in close proximity to the topside of the transparent member 112, energy is blocked from being received by the optical component 116. A computer or the like may then use information from the optical component 116 regarding the lack of energy received to determine the location of the blockage, through triangulation or similar means as would be obvious to a person skilled in the art. Of course, embodiments also include those in which a different principle is used for touch detection—for example, the detector may be used to generate an image of the field of view and image processing techniques can be used, etc.

The manner by which the touch screen system 110 may be assembled will now be described. First, a sheet of transparent member 112 may be cut to the required size, then the corners where it is desired a optical component 116 be located be cut so as to define a corner portion 112a, as shown in FIG. 13. Next, the support member 114 is attached to the underside of the transparent member 112a by glue or the like, such that a portion 114a of the support member 114 extends into the corner portion 112a. The reflector support member 120 with reflective member 122 fixedly attached may be attached to the periphery of the topside of the transparent member 112 either before or after placement of the optical component 116 on the support member 114, however it is advantageous that it is placed after the corners of the transparent member 112 have been cut to define corner portions 112a.

Once assembled, the touch screen system 110 may be placed upon a display such as a LCD, Cathode Ray Tube (CRT) or Plasma display (not shown). Due to transparent member 112, the display is externally viewable and contact upon the transparent member 112 gives the impression of contact with the display by a user. In one aspect, the bottom surface of the optical component 116 is located below the transparent member 112, as can be seen in the Figures. After system 110 is placed on the panel, an appropriate screen bezel can then be positioned over the panel.

In another aspect of the present invention, in a case where the touch screen system 110 comprises an LCD without a transparent member 112, the optical component 116 may be located partially or completely below the polarizer (not shown) of the LCD. The principles noted above are used when assembling the LCD sandwich structure, with the polarizer taking the place of transparent member 112 in the examples above.

Specifically, a corner or edge portion of the polarizer can be cut away or omitted, with a support member positioned at the underside of the cut-away portion(s). An optical component (e.g., emitter, detector, reflector, etc.) can be positioned on the support member. The LCD sandwich structure can then be formed using the polarizer and support member by placing the polarizer with support member and optical components over the remainder of the sandwich. The support member may extend into the LCD sandwich at the corner(s) or other cut-away portions. Alternatively, the area of the polarizer may exceed the area of the remainder of the sandwich so that the support member at the underside of the polarizer sits at an edge of the remainder of the sandwich structure. In any event, the optical component on the support member extends above the topside of the polarizer but also partially below the polarizer. Reflective members or other optical components can be added to the surface of the polarizer as needed. A panel bezel can then be used to secure the LCD sandwich and optical components, with a screen bezel then positioned over the completed LCD display device.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed:

1. A touch-enabled display, comprising:
a display device comprising a generally planar panel;
a panel bezel surrounding the panel at edges of the panel;
a screen bezel surrounding the display device and the panel bezel; and
at least one optical component,
wherein the at least one optical component is positioned between the panel and the panel bezel.

2. The touch-enabled display set forth in claim 1,
wherein the panel comprises an LCD panel with a polarizer defining a top surface of the panel, and
wherein the at least one optical component is secured to the polarizer.

3. The touch-enabled display set forth in claim 1,
wherein the display device comprises a polarizer and a transparent member atop the polarizer, and
wherein the at least one optical component is secured to the transparent member.

4. The touch-enabled display set forth in claim 1,
wherein the at least one optical component comprises a reflective material affixed to a support member.

5. The touch-enabled display set forth in claim 1, wherein the at least one optical component comprises an energy detector.

6. The touch-enabled display set forth in claim 1,
wherein the panel bezel comprises a support portion that extends toward the plane from a portion of the panel bezel parallel to and above the plane, and
wherein the support portion is adapted to receive the optical component.

7. The touch-enabled display set forth in claim 6,
wherein the panel bezel is adapted to receive a portion of the screen bezel to secure the screen bezel and the panel bezel.

8. The touch-enabled display set forth in claim 1, wherein the at least one optical component comprises a reflective material affixed to a support member,
wherein the touch-enabled display further comprises a frame member fitted to the panel over the panel bezel, the frame member comprising at least one additional optical component, and
wherein the frame member is positioned between the panel bezel and the screen bezel.

9. A touch-enabled display, comprising:
a display device comprising a generally planar panel;
a panel bezel surrounding the panel at edges of the panel;
a frame member fitted to the panel over the panel bezel, the frame member comprising at least one additional optical component;
a screen bezel surrounding the display device, the panel bezel, and the frame member, and
at least one optical component carried by the frame member and positioned proximate to the panel.

10. The touch-enabled display set forth in claim 9, wherein the at least one optical component comprises a detector.

11. The touch-enabled display set forth in claim 9, further comprising a reflective material positioned proximate the panel and in the field of view of the detector.

12. The touch-enabled display set forth in claim 11, wherein the reflective material is positioned on a support member, the support member between a surface of the panel and the panel bezel.

13. The touch-enabled display set forth in claim 11, wherein the reflective material is positioned on the frame so that when the frame is fitted to the panel, the reflective material is in the field of view of the detector.

14. A method of assembling a touch-enabled display, the method comprising:
providing a display device defining a panel;
positioning at least one optical component proximate a surface defined by the display device; and
fitting a screen bezel over the panel and the at least one optical component.

15. The method set forth in claim 14,
wherein the display device comprises a panel bezel, and
wherein positioning the at least one optical component comprises positioning the at least one optical component on the surface so that the component is between the surface and the panel bezel.

16. The method set forth in claim 14,
wherein the display device comprises a panel bezel, and
wherein positioning the at least one optical component comprises fitting a frame carrying the at least one optical component to the panel and panel bezel,
wherein the screen bezel surrounds the panel and the frame.

17. The method set forth in claim 14, wherein positioning the at least one optical component comprises:
providing a transparent member having a corner cut to define a corner portion,
attaching a support member at the corner portion,
positioning the optical component on the support member, and
prior to fitting the screen bezel over the panel, placing the transparent member over the panel so that the optical component is proximate the surface.

18. The method set forth in claim 17, wherein the support member defines a top side and a bottom side, the top side of the support member placed in contact with an underside of the transparent member so that when the optical component is positioned on the top side of the support member, a field of view of the optical component encompasses at least a portion of the top side of the transparent member.

19. The method set forth in claim 14, wherein the optical component comprises a detector.
